(19) United States
(12) Patent Application Publication
(10) Pub. No.: US 2018/0142754 A1
(43) Pub. Date: May 24, 2018

(54) Variable Damping Shock Absorber and Washing Machine

(71) Applicant: QINGDAO HAIER WASHING MACHINE CO., LTD., Qingdao, Shandong (CN)

(72) Inventors: Sheng XU, Qingdao (CN); Yanfen LV, Qingdao (CN); Xiuwen PENG, Qingdao (CN); Liang XU, Qingdao (CN)

(21) Appl. No.: 15/570,299

(22) PCT Filed: Apr. 29, 2016
(86) PCT No.: PCT/CN2016/080657

§ 371 Date: Oct. 27, 2017

(30) Foreign Application Priority Data
Apr. 30, 2015 (CN) 201510218889.5

(51) Int. Cl. F16F 7/09; D06F 37/22

(52) U.S. Cl. CPC F16F 7/09; D06F 37/22

(57) ABSTRACT

A variable damping shock absorber includes a housing and a piston rod capable of sliding along an inner wall of the housing. A first damping unit is fixedly arranged on the piston rod, which moves with the piston rod and generates frictional force with the inner wall of the housing. An accommodating space is formed between a part of the piston rod and the inner wall of the housing. A second damping unit matched with the inner wall of the housing is arranged in the accommodating space. The second damping unit vertically moves along the inner wall of the housing, and generates frictional force with the inner wall of the housing.

### TECHNICAL FIELD

The present disclosure relates to the field of shock absorbing apparatuses and washing machines, and more specifically, discloses a variable damping shock absorber capable of adjusting the damping of a shock absorber according to a shock condition in a use process, and a washing machine provided with the variable damping shock absorber.

### BACKGROUND

A shock absorber and an elastic element assume tasks of relieving impact and absorbing shock. When damping force is too large, it is easy to damage a connecting piece in the shock absorber, and when the damping force is too small, a shock absorbing effect cannot be realized.

The shock absorber can be applied to the washing machine. A drum washing machine is designed to absorb shock generated by a washing drum in a washing process through the washing drum made by a four-point shock absorber. Namely, the shock absorber for supporting the washing drum of the washing machine reduces the shock generated by the rotation of the washing drum through absorbing the shock, and provides holding force for supporting the washing drum, so that additional holding members such as a suspension and the like are not needed.

In the field of the washing machine, shock amplitudes generated during a normal dewatering operation and during an excessive dewatering operation under an actual washing operation are quite different. Thus, an effective attenuation for large-amplitude shock and small-amplitude shock is limited. In an existing shock absorber of the drum washing machine, shock absorbing frictional force is basically constant at all times, so change and adjustment of damping cannot be realized. If a constant damping is set, then a shock absorbing effect is poor when the shock is too large.

Therefore, a variable damping shock absorber and a washing machine with the shock absorber are urgently needed in a market, so that the shock absorber can automatically change the damping according to different shock conditions in an operation process, thereby effectively absorbing shock and enhancing a shock absorbing effect.

### SUMMARY

One purpose of the present disclosure is to propose a variable damping shock absorber capable of adjusting a damping itself according to an outside shock situation in a use process, thereby effectively absorbing shock and enhancing a shock absorbing effect.

Another purpose of the present disclosure is to propose a washing machine on which the variable damping shock absorber is arranged, so as to solve a problem of large shock in an operation process of the washing machine in an existing art.

To achieve the purpose, on one hand, the present disclosure adopts the following technical solution:

A variable damping shock absorber includes a housing and a piston rod arranged within the housing and capable of sliding along an inner wall of the housing. A first damping unit is fixedly arranged on the piston rod. The first damping unit moves with the piston rod and generates frictional force with the inner wall of the housing. An accommodating space is formed between a part of the piston rod and the inner wall of the housing. A second damping unit matched with the inner wall of the housing is arranged in the accommodating space. The second damping unit vertically moves along the inner wall of the housing, and generates frictional force with the inner wall of the housing.

When a stroke of the shock absorber is less than a preset value, the second damping unit is fixed relative to the inner wall of the housing.

When the stroke of the shock absorber is greater than the preset value, the second damping unit vertically moves along the inner wall of the housing.

Further, the piston rod has an upper supporting end and a lower supporting end. A rod body extends between the upper supporting end and the lower supporting end. The upper supporting end and the lower supporting end are arranged to protrude from the rod body so that the accommodating space is formed between the rod body and the inner wall of the housing.

A separating piece protruding from the rod body is also arranged on the rod body between the upper supporting end and the lower supporting end.

Further, the second damping unit is arranged between the upper supporting end and the separating piece.

When the stroke of the shock absorber is greater than the preset value, the second damping unit vertically moves along the inner wall of the housing under the pushing of the upper supporting end or the separating piece.

Further, the first damping unit is a damping ring.

The damping ring is fixedly arranged around an outer surface of the upper supporting end and comes into contact with the inner wall of the housing.

Further, the second damping unit includes a holding frame and a damping sleeve. The holding frame is a hollow structure that is not closed at an upper end and a lower end thereof.

The upper end and the lower end of the holding frame are bent 90° upwards and downwards respectively to form an upper bent part and a lower bent part.

A damping sleeve is arranged around an outer wall of the holding frame between the upper bent part and the lower bent part.

An interference fit is formed between the holding frame and the damping sleeve.

Further, the holding frame and the damping sleeve are separated structures.

The holding frame and the damping sleeve are divided into two parts of symmetry by a section that passes through its diameter along an axial direction.

Further, two parts of the holding frame are installed together to form a holding frame installing interface.

Two parts of the damping sleeve are installed together to form a damping sleeve installing interface.

The holding frame installing interface and the damping sleeve installing interface are arranged staggerly.

Preferably, a length M of the first damping unit is 5-25 mm.

Preferably, a length of the second damping unit is L=a*K,

wherein K is a length of the accommodating space and a is 0.2-0.8 mm.

On the other hand, the present disclosure adopts the following technical solution:

A washing machine on which the above variable damping shock absorber is arranged.

The present disclosure has beneficial effects as follows: the piston rod of the shock absorber in the present disclosure is provided with a first damping unit and a second damping unit. The first damping unit moves with the piston rod. The second damping unit is matched with the inner wall of the housing. When the stroke of the shock absorber is less than the preset value, the second damping unit is fixed relative to the inner wall of the housing, and when the stroke of the shock absorber is greater than the preset value, the second damping unit vertically moves along the inner wall of the housing. Since the shock absorber in the present disclosure has the above structure, the shock absorber can automatically adjust damping itself according to a size of shock suffered in a use process, thereby effectively absorbing shock and enhancing a shock absorbing effect.

The above shock absorber is arranged on the washing machine in the present disclosure, so as to adapt to various working conditions of the washing machine in the use process, thereby effectively relieving shock of the washing machine, reducing noise in a washing process of the washing machine and enhancing the user experience.

### BRIEF DESCRIPTION OF DRAWINGS

FIG. 1 is a half-sectional structural schematic diagram of a variable damping shock absorber according to the first embodiment of the present disclosure.

FIG. 2 is a front views of a piston rod according to the first embodiment of the present disclosure.

FIG. 3 is an exploded structural diagram of a second damping unit according to the first embodiment of the present disclosure.

FIG. 4 is an assembly structural diagram of a second damping unit according to the first embodiment of the present disclosure.

### IN THE FIGURES

1. housing 2. piston rod 21. upper supporting end 22. lower supporting end 23. rod body 24. separating piece 3. first damping unit 4. second damping unit 41. holding frame 42. damping sleeve

### DETAILED DESCRIPTION

The technical solution of the present disclosure will be further described below in combination with drawings and through specific embodiments.

### Embodiment 1

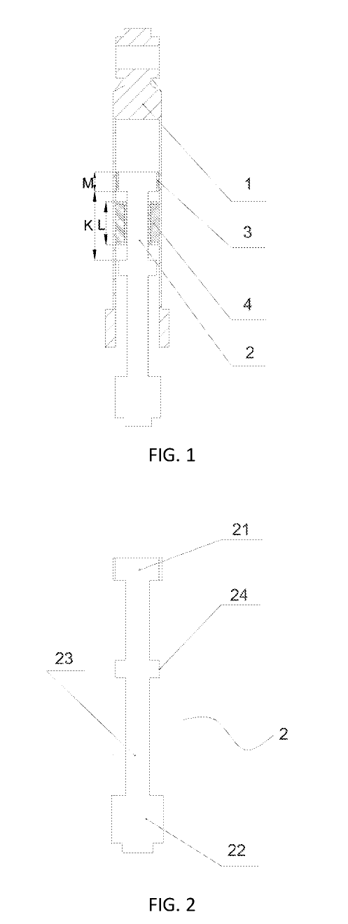

FIG. 1 shows a variable damping shock absorber according to the present embodiment, including a housing 1 and a piston rod 2 arranged in the housing 1 and capable of sliding along an inner wall of the housing 1. A first damping unit 3 is fixedly provided on the piston rod 2. The first damping unit 3 moves with the piston rod 2 and generates frictional force with the inner wall of the housing 1. A second damping unit 4 is also provided on the piston rod 2.

An accommodating space is formed between a part of the piston rod 2 and the inner wall of the housing 1 in the present embodiment. A second damping unit 4 matched with the inner wall of the housing 1 is arranged in the accommodating space. The second damping unit 4 vertically moves along the inner wall of the housing 1, and generates frictional force with the inner wall of the housing 1. When the stroke of the shock absorber is less than the preset value, the second damping unit 4 is fixed relative to the inner wall of the housing 1, and when the stroke of the shock absorber is greater than the preset value, the second damping unit 4 vertically moves along the inner wall of the housing 1. The preset value of the stroke in the present embodiment is related to a structure of the piston rod 2, and can be designed according to a specific use condition of the shock absorber. In the present embodiment, a length M of the first damping unit 3 is 5-25 mm. Preferably, M is 10-15 mm. A length of the second damping unit 4 is L=a*K, wherein K is a length of the accommodating space and a is 0.2-0.8 mm. Preferably, a is 0.3-0.5 mm. The preset value is calculated in combination with actual conditions in the use process of the shock absorber and the above parameters.

As shown in FIG. 2, as a still further embodiment, the piston rod 2 has an upper supporting end 21 and a lower supporting end 22. A rod body 23 extends between the upper supporting end 21 and the lower supporting end 22. The upper supporting end 21 and the lower supporting end 22 are arranged to protrude from the rod body 23 so that the accommodating space is formed between the rod body 23 and the inner wall of the housing 1. A separating piece 24 protruding from the rod body 23 is also arranged on the rod body 23 between the upper supporting end 21 and the lower supporting end 22. The second damping unit 4 is arranged between the upper supporting end 21 and the separating piece 24. When the stroke of the shock absorber is greater than the preset value, the second damping unit 4 vertically moves along the inner wall of the housing 1 under the pushing of the upper supporting end 21 or the separating piece 24. In the present embodiment, the piston rod 2 is an integrally formed structure, wherein the separating piece 24, the upper supporting end 21, the lower supporting end 22 and the rod body 23 are integrally processed and formed.

Preferably, the first damping unit 3 in the present embodiment is a damping ring. The damping ring is fixedly arranged around an outer surface of the upper supporting end 21 and comes into contact with the inner wall of the housing 1.

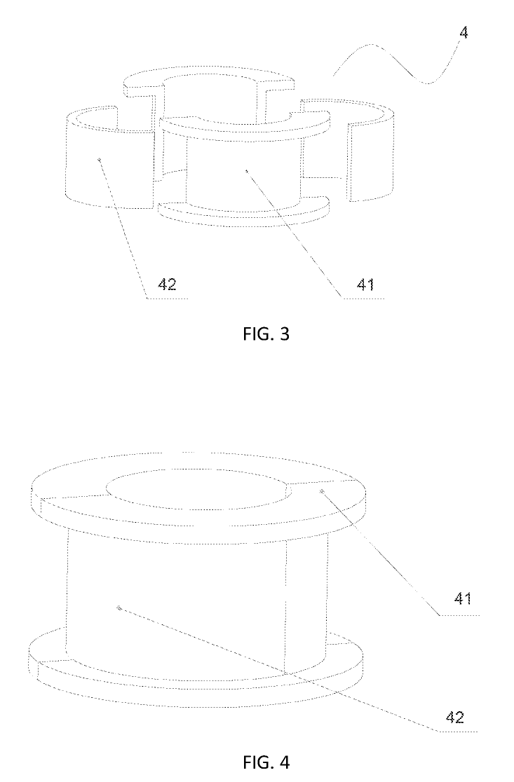

As shown in FIG. 3 and FIG. 4, the second damping unit 4 includes a holding frame 41 and a damping sleeve 42, and the holding frame 41 is a hollow structure that is not closed at an upper end and a lower end thereof. The upper end and the lower end of the holding frame 41 are bent 90° upwards and downwards respectively to form an upper bent part and a lower bent part. Therefore, a half section of the holding frame 41 along its axis presents an I-shaped structure. A damping sleeve 42 is arranged around an outer wall of the holding frame 41 between the upper bent part and the lower bent part. An interference fit is formed between the holding frame 41 and the damping sleeve 42. A half section of the damping sleeve 42 along its axis is rectangular.

The holding frame 41 and the damping sleeve 42 are separated structures. Preferably, the holding frame 41 and the damping sleeve 42 are divided into two parts of symmetry by a section that passes through its diameter along an axial direction. Two parts of the holding frame 41 are installed together to form a holding frame installing interface. Two parts of the damping sleeve 42 are installed together to form a damping sleeve installing interface. The holding frame installing interface and the damping sleeve installing interface are arranged staggerly.

Since the separating piece 24 is arranged on the piston rod 2 in the present embodiment, the holding frame 41 and the damping sleeve 42 of the second damping unit 4 are configured as separated structures for the convenience of installation. During installation, the holding frame 41 is firstly installed on the piston rod 2, and two parts of the holding frame 41 are aligned and buckled together and then closed. Then, the damping sleeve 42 is sleeved between the upper bent part and the lower bent part. After that, the two parts of the damping sleeve 42 are buckled together and are in close fit, so that the holding frame 41 and the damping sleeve 42 can move together.

Preferably, the first damping unit 3 and the second damping unit 4 in the present embodiment are made of high-density polyurethane or rubber, but not limited to above material.

Due to the above structure of the shock absorber in the present embodiment, the shock absorber can automatically adjust the damping itself according to a size of shock suffered in the use process, thereby effectively absorbing shock and enhancing a shock absorbing effect.

### Embodiment 2

The present embodiment proposes a washing machine on which the variable damping shock absorber described in embodiment 1 is arranged, so that the washing machine in the present embodiment can effectively relieve the shock generated in various washing procedures of the washing machine in the washing process, thereby reducing noise in the washing process of the washing machine and enhancing the user experience.

Technical principles of the present disclosure are described above in combination with the specific embodiments. These descriptions are only used to explain the principles of the present disclosure, and are not interpreted as limitations to a protection scope of the present disclosure in any way. Based on explanation herein, those skilled in the art can contemplate other specific embodiments of the present disclosure without contributing creative labor. These embodiments shall fall into the protection scope of the present disclosure.

1. A variable damping shock absorber, comprising a housing and a piston rod arranged in the housing and capable of sliding along an inner wall of the housing, a first damping unit is fixedly arranged on the piston rod, the first damping unit moves with the piston rod and generates frictional force with the inner wall of the housing, wherein an accommodating space is formed between a part of the piston rod and the inner wall of the housing, a second damping unit matched with the inner wall of the housing is arranged in the accommodating space, and the second damping unit vertically moves along the inner wall of the housing, and generates frictional force with the inner wall of the housing,
when a stroke of the shock absorber is less than a preset value, the second damping unit is fixed relative to the inner wall of the housing, and
when the stroke of the shock absorber is greater than the preset value, the second damping unit vertically moves along the inner wall of the housing.

2. The variable damping shock absorber according to claim 1, wherein the piston rod has an upper supporting end and a lower supporting end, a rod body extends between the upper supporting end and the lower supporting end, and the upper supporting end and the lower supporting end are arranged to protrude from the rod body so that the accommodating space is formed between the rod body and the inner wall of the shell, and
a separating piece protruding from the rod body is also arranged on the rod body between the upper supporting end and the lower supporting end.

3. The variable damping shock absorber according to claim 2, wherein the second damping unit is arranged between the upper supporting end and the separating piece, and
when the stroke of the shock absorber is greater than the preset value, the second damping unit vertically moves along the inner wall of the housing under the pushing of the upper supporting end or the separating piece.

4. The variable damping shock absorber according to claim 3, wherein the first damping unit is a damping ring, and
the damping ring is fixedly arranged around an outer surface of the upper supporting end; and comes into contact with the inner wall of the housing.

5. The variable damping shock absorber according to claim 1, wherein the second damping unit comprises a holding frame and a damping sleeve, and the holding frame is a hollow structure that is not closed at an upper end and a lower end,
the upper end and the lower end of the holding frame are bent 90° upwards and downwards respectively to form an upper bent part and a lower bent part,
a damping sleeve is arranged around an outer wall of the holding frame between the upper bent part and the lower bent part, and
an interference fit is formed between the holding frame and the damping sleeve.

6. The variable damping shock absorber according to claim 5, wherein the holding frame and the damping sleeve are separated structures, and
the holding frame and the damping sleeve are divided into two parts of symmetry by a section that passes through its diameter along an axial direction.

7. The variable damping shock absorber according to claim 6, wherein two parts of the holding frame are installed together to form a holding frame installing interface,
two parts of the damping sleeve are installed together to form a damping sleeve installing interface, and
the holding frame installing interface and the damping sleeve installing interface are arranged staggerly.

8. The variable damping shock absorber according to claim 1, wherein a length M of the first damping unit is 5-25 mm.

9. The variable damping shock absorber according to claim 1, wherein a length of the second damping unit is L=a*K, wherein K is a length of the accommodating space and a is 0.2-0.8 mm.

10. A washing machine, wherein the washing machine is provided with the variable damping shock absorber according to claim 1.
